(19) United States
(12) Patent Application Publication
(10) Pub. No.: US 2026/0278834 A1
(43) Pub. Date: Sep. 17, 2026

(54) CAMERA LOCALIZATION USING RANDOM SAMPLING OF IMAGE FEATURES

(71) Applicant: Niantic Spatial, Inc., San Francisco, CA (US)

(72) Inventors: Axel Barroso-Laguna, Barcelona (ES); Tommaso Cavallari, Oxford (GB); Victor Adrian Prisacariu, Oxford (GB); Eric Brachmann, Dresden (DE)

(21) Appl. No.: 19/568,186

(22) Filed: Mar. 16, 2026

Related U.S. Application Data
(60) Provisional application No. 63/773,385, filed on Mar. 17, 2025.

(51) Int. Cl. G06T 7/73

(52) U.S. Cl. CPC G06T 7/74; G06T 2207/30244

(57) ABSTRACT

A game server uses a foundation model to predict a pose for an image based on reference images. The game server receives an image from a client device and generates feature tokens using a feature encoder. The game server selects reference images based on an estimated pose associated with the received image and accesses feature tokens for the selected reference images. The game server selects a subset of feature tokens and applies a foundation model to predict a final pose for the image. The foundation model is trained to predict poses based on input feature tokens. The game server may randomly sample feature tokens to create a map representation and incorporate ray encodings representing viewing directions and camera positions. The game server generates AR content based on the image and final pose and transmits the AR content to the client device for display.

### CROSS-REFERENCE TO RELATED APPLICATIONS

This application claims the benefit of U.S. Provisional Patent Application No. 63/773,385, filed Mar. 17, 2025, which is incorporated by reference.

### BACKGROUND

Image localization (or camera localization) is a process of determining a pose of a camera when the camera took a query image. For example, an image localization system may determine GPS coordinates for a location at which an image was captured and the direction in which the camera was facing when it captured the image.

Normally, image localization is a computationally expensive process. Image localization systems typically perform one of two approaches. The first approach uses a 3D model of an area. Specifically, they may generate a 3D model of a geographical area based on a set of reference images. The system may compare a query image to the 3D model by performing an image matching process, and thereby determine a pose corresponding to the query image. The second approach is to train a bespoke machine-learning model for predicting an image's pose. This machine-learning model is trained based on a set of images within a target geographic area to ensure sufficient performance.

The poses for query images may be obtained through various methods. Poses may be provided by recording devices running visual-inertial odometry or simultaneous localization and mapping (SLAM) systems. Alternatively, poses may be estimated afterwards by running structure-from-motion with scale estimation or geo-referencing techniques. In some embodiments, the poses may be estimated by the machine-learning model itself during training.

However, these approaches are very expensive from a time and storage perspective, as they need to be prepared for any location in which a user may be located. In addition, these approaches generally require the processing of entire reference images, which is similarly computationally expensive.

### SUMMARY

A game server uses a foundation model to predict a pose for an image based on a set of reference images. The game server receives an image from a client device and generates a set of feature tokens for the image by applying a feature encoder to the received image. The game server selects a set of reference images from a plurality of reference images based on an estimated pose associated with the image. Each reference image is associated with a pose at which the reference image was captured. The game server accesses feature tokens for the selected reference images and selects a subset of the feature tokens for processing.

The game server applies a foundation model to the feature tokens for the received image and the selected subset of feature tokens to generate a final pose for the image. The foundation model is a machine-learning model trained to predict poses for images based on input feature tokens. The game server may randomly sample feature tokens from the reference images to create a map representation that maintains consistent processing requirements regardless of the number of reference images used. The game server also may incorporate ray encodings into the feature tokens that represent viewing directions and camera positions from the poses of the reference images.

By generating feature tokens of a received image and of reference images, the game server can use a foundation model to generate a prediction for the pose of the received image, without having to generate a three-dimensional model of a geographic area or a bespoke machine-learning model. This reduces the resources required to localize images within a new area; rather than having to build a 3D model or train a machine-learning model, the game server can simply use a set of reference images with corresponding poses. Furthermore, by selecting a subset of feature tokens for the reference images, the game server reduces the data required to be input to the foundation model, which reduces the computational resources required to execute the foundation model.

### BRIEF DESCRIPTION OF THE DRAWINGS

FIG. 1 is a conceptual diagram of a virtual world that parallels the real world.

FIG. 2 depicts one embodiment of a game interface that can be presented (e.g., on a player's smartphone) as part of the interface between the player and the virtual world.

FIG. 3 illustrates one embodiment of a networked computing environment.

FIG. 4 is a flowchart for a method of localizing a client device based on a reference image and providing AR content based on the localization, in accordance with some embodiments.

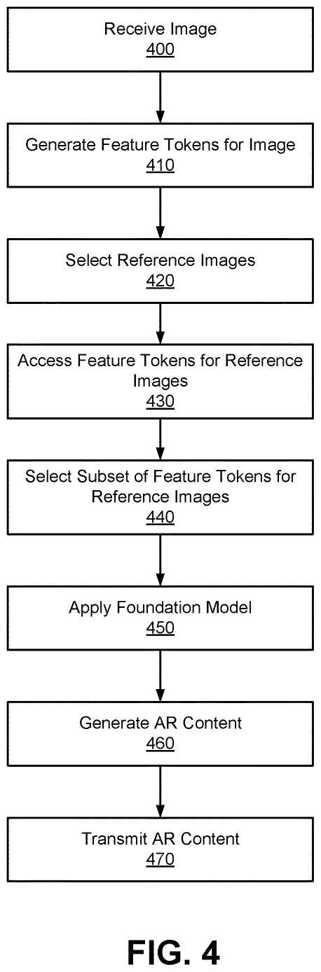

FIG. 5 illustrates an example data flow for generating a final pose for an image using reference images and a foundation model, in accordance with some embodiments.

### DETAILED DESCRIPTION

The figures and the following description describe certain embodiments by way of illustration only. One skilled in the art will recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

Various embodiments are described in the context of a parallel reality game that includes augmented reality content in a virtual world geography that parallels at least a portion of the real-world geography such that player movement and actions in the real-world affect actions in the virtual world. The subject matter described is applicable in other situations where image localization is desirable. In addition, the inherent flexibility of computer-based systems allows for a great variety of possible configurations, combinations, and divisions of tasks and functionality between and among the components of the system.

### Example Location-Based Parallel Reality Game

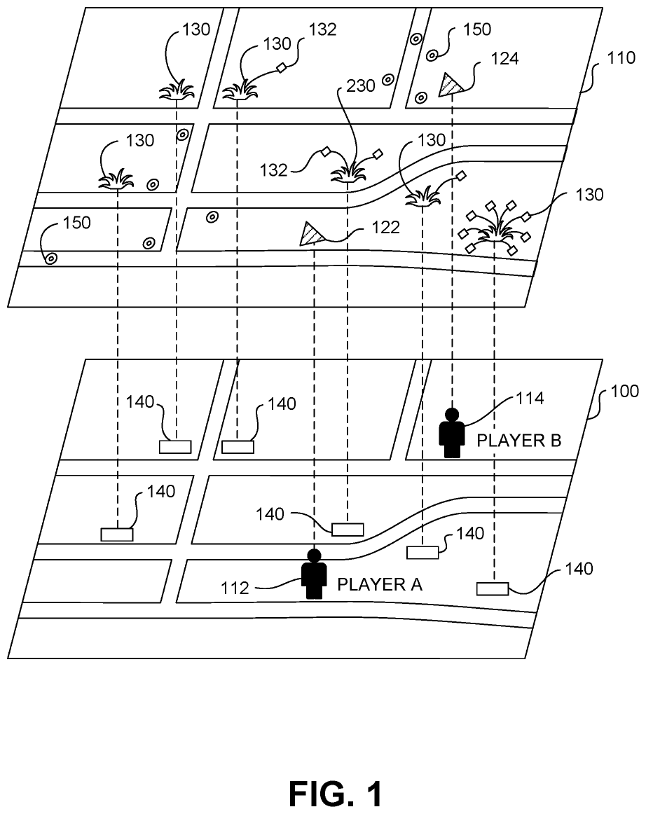

FIG. 1 is a conceptual diagram of a virtual world 110 that parallels the real world 100. The virtual world 110 can act as the game board for players of a parallel reality game. As illustrated, the virtual world 110 includes a geography that parallels the geography of the real world 100. In particular, a range of coordinates defining a geographic area or space in the real world 100 is mapped to a corresponding range of coordinates defining a virtual space in the virtual world 110. The range of coordinates in the real world 100 can be associated with a town, neighborhood, city, campus, locale, a country, continent, the entire globe, or other geographic area. Each geographic coordinate in the range of geographic coordinates is mapped to a corresponding coordinate in a virtual space in the virtual world 110.

A player's position in the virtual world 110 corresponds to the player's position in the real world 100. For instance, player A located at position 112 in the real world 100 has a corresponding position 122 in the virtual world 110. Similarly, player B located at position 114 in the real world 100 has a corresponding position 124 in the virtual world 110. As the players move about in a range of geographic coordinates in the real world 100, the players also move about in the range of coordinates defining the virtual space in the virtual world 110. In particular, a positioning system (e.g., a GPS system, a localization system, or both) associated with a mobile computing device carried by the player can be used to track a player's position as the player navigates the range of geographic coordinates in the real world 100. Data associated with the player's position in the real world 100 is used to update the player's position in the corresponding range of coordinates defining the virtual space in the virtual world 110. In this manner, players can navigate along a continuous track in the range of coordinates defining the virtual space in the virtual world 110 by simply traveling among the corresponding range of geographic coordinates in the real world 100 without having to check in or periodically update location information at specific discrete locations in the real world 100.

The location-based game can include game objectives requiring players to travel to or interact with various virtual elements or virtual objects scattered at various virtual locations in the virtual world 110. A player can travel to these virtual locations by traveling to the corresponding location of the virtual elements or objects in the real world 100. For instance, a positioning system can track the position of the player such that as the player navigates the real world 100, the player also navigates the parallel virtual world 110. The player can then interact with various virtual elements and objects at the specific location to achieve or perform one or more game objectives.

A game objective may have players interacting with virtual elements 130 located at various virtual locations in the virtual world 110. These virtual elements 130 can be linked to landmarks, geographic locations, or objects 140 in the real world 100. The real-world landmarks or objects 140 can be works of art, monuments, buildings, businesses, libraries, museums, or other suitable real-world landmarks or objects. Interactions include capturing, claiming ownership of, using some virtual item, spending some virtual currency, etc. To capture these virtual elements 130, a player travels to the landmark or geographic locations 140 linked to the virtual elements 130 in the real world and performs any necessary interactions (as defined by the game's rules) with the virtual elements 130 in the virtual world 110. For example, player A may have to travel to a landmark 140 in the real world 100 to interact with or capture a virtual element 130 linked with that particular landmark 140. The interaction with the virtual element 130 can require action in the real world, such as taking a photograph or verifying, obtaining, or capturing other information about the landmark or object 140 associated with the virtual element 130.

Game objectives may require that players use one or more virtual items that are collected by the players in the location-based game. For instance, the players may travel the virtual world 110 seeking virtual items 132 (e.g., weapons, creatures, power ups, or other items) that can be useful for completing game objectives. These virtual items 132 can be found or collected by traveling to different locations in the real world 100 or by completing various actions in either the virtual world 110 or the real world 100 (such as interacting with virtual elements 130, battling non-player characters or other players, or completing quests, etc.). In the example shown in FIG. 1, a player uses virtual items 132 to capture one or more virtual elements 130. In particular, a player can deploy virtual items 132 at locations in the virtual world 110 near to or within the virtual elements 130. Deploying one or more virtual items 132 in this manner can result in the capture of the virtual element 130 for the player or for the team/faction of the player.

In one particular implementation, a player may have to gather virtual energy as part of the parallel reality game. Virtual energy 150 can be scattered at different locations in the virtual world 110. A player can collect the virtual energy 150 by traveling to (or within a threshold distance of) the location in the real world 100 that corresponds to the location of the virtual energy in the virtual world 110. The virtual energy 150 can be used to power virtual items or perform various game objectives in the game. A player that loses all virtual energy 150 may be disconnected from the game or prevented from playing for a certain amount of time or until they have collected additional virtual energy 150.

According to aspects of the present disclosure, the parallel reality game can be a massive multi-player location-based game where every participant in the game shares the same virtual world. The players can be divided into separate teams or factions and can work together to achieve one or more game objectives, such as to capture or claim ownership of a virtual element. In this manner, the parallel reality game can intrinsically be a social game that encourages cooperation among players within the game. Players from opposing teams can work against each other (or sometime collaborate to achieve mutual objectives) during the parallel reality game. A player may use virtual items to attack or impede progress of players on opposing teams. In some cases, players are encouraged to congregate at real world locations for cooperative or interactive events in the parallel reality game. In these cases, the game server seeks to ensure players are indeed physically present and not spoofing their locations.

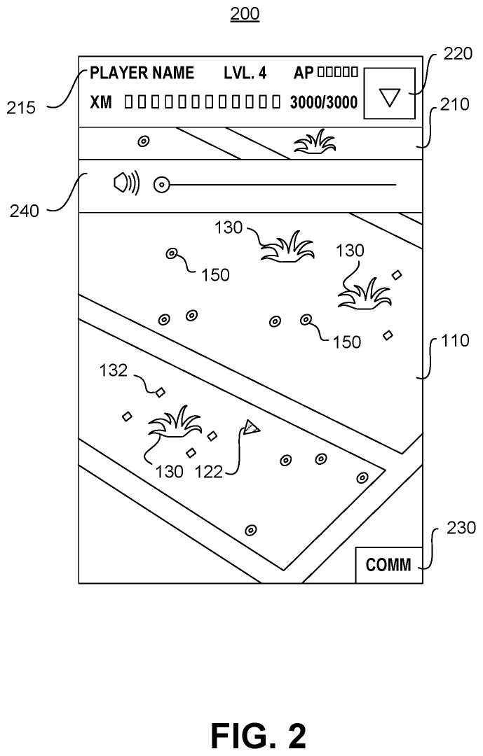

FIG. 2 depicts one embodiment of a game interface 200 that can be presented (e.g., on a player's smartphone) as part of the interface between the player and the virtual world 110. The game interface 200 includes a display window 210 that can be used to display the virtual world 110 and various other aspects of the game, such as player position 122 and the locations of virtual elements 130, virtual items 132, and virtual energy 150 in the virtual world 110. The user interface 200 can also display other information, such as game data information, game communications, player information, client location verification instructions and other information associated with the game. For example, the user interface can display player information 215, such as player name, experience level, and other information. The user interface 200 can include a menu 220 for accessing various game settings and other information associated with the game. The user interface 200 can also include a communications interface 230 that enables communications between the game system and the player and between one or more players of the parallel reality game.

According to aspects of the present disclosure, a player can interact with the parallel reality game by carrying a client device around in the real world. For instance, a player can play the game by accessing an application associated with the parallel reality game on a smartphone and moving about in the real world with the smartphone. In this regard, it is not necessary for the player to continuously view a visual representation of the virtual world on a display screen in order to play the location-based game. As a result, the user interface 200 can include non-visual elements that allow a user to interact with the game. For instance, the game interface can provide audible notifications to the player when the player is approaching a virtual element or object in the game or when an important event happens in the parallel reality game. In some embodiments, a player can control these audible notifications with audio control 240. Different types of audible notifications can be provided to the user depending on the type of virtual element or event. The audible notification can increase or decrease in frequency or volume depending on a player's proximity to a virtual element or object. Other non-visual notifications and signals can be provided to the user, such as a vibratory notification or other suitable notifications or signals.

The parallel reality game can have various features to enhance and encourage game play within the parallel reality game. For instance, players can accumulate a virtual currency or another virtual reward (e.g., virtual tokens, virtual points, virtual material resources, etc.) that can be used throughout the game (e.g., to purchase in-game items, to redeem other items, to craft items, etc.). Players can advance through various levels as the players complete one or more game objectives and gain experience within the game. Players may also be able to obtain enhanced “powers” or virtual items that can be used to complete game objectives within the game.

Those of ordinary skill in the art, using the disclosures provided, will appreciate that numerous game interface configurations and underlying functionalities are possible. The present disclosure is not intended to be limited to any one particular configuration unless it is explicitly stated to the contrary.

### Example Gaming System

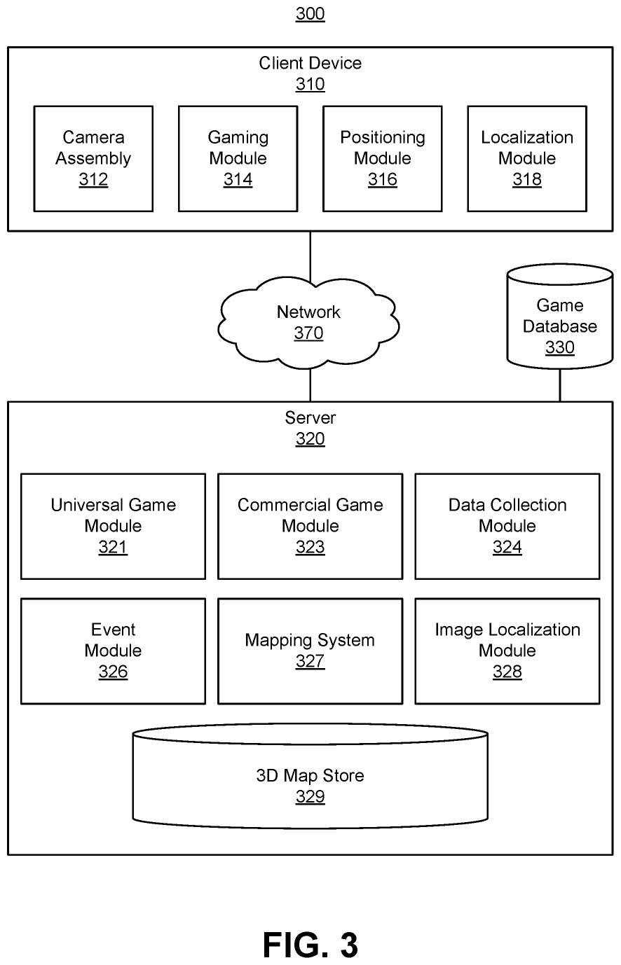

FIG. 3 illustrates one embodiment of a networked computing environment 300. The networked computing environment 300 uses a client-server architecture, where a game server 320 communicates with a client device 310 over a network 370 to provide a parallel reality game to a player at the client device 310. The networked computing environment 300 also may include other external systems such as sponsor/advertiser systems or business systems. Although only one client device 310 is shown in FIG. 3, any number of client devices 310 or other external systems may be connected to the game server 320 over the network 370. Furthermore, the networked computing environment 300 may contain different or additional elements and functionality may be distributed between the client device 310 and the server 320 in different manners than described below.

The networked computing environment 300 provides for the interaction of players in a virtual world having a geography that parallels the real world. In particular, a geographic area in the real world can be linked or mapped directly to a corresponding area in the virtual world. A player can move about in the virtual world by moving to various geographic locations in the real world. For instance, a player's position in the real world can be tracked and used to update the player's position in the virtual world. Typically, the player's position in the real world is determined by finding the location of a client device 310 through which the player is interacting with the virtual world and assuming the player is at the same (or approximately the same) location. For example, in various embodiments, the player may interact with a virtual element if the player's location in the real world is within a threshold distance (e.g., ten meters, twenty meters, etc.) of the real-world location that corresponds to the virtual location of the virtual element in the virtual world. For convenience, various embodiments are described with reference to “the player's location” but one of skill in the art will appreciate that such references may refer to the location of the player's client device 310.

A client device 310 can be any portable computing device capable for use by a player to interface with the game server 320. For instance, a client device 310 is preferably a portable wireless device that can be carried by a player, such as a smartphone, portable gaming device, augmented reality (AR) headset, cellular phone, tablet, personal digital assistant (PDA), navigation system, handheld GPS system, or other such device. For some use cases, the client device 310 may be a less-mobile device such as a desktop or a laptop computer. Furthermore, the client device 310 may be a vehicle with a built-in computing device.

The client device 310 communicates with the game server 320 to provide sensory data of a physical environment. In one embodiment, the client device 310 includes a camera assembly 312, a gaming module 314, a positioning module 316, and a localization module 318. The client device 310 also includes a network interface (not shown) for providing communications over the network 370. In various embodiments, the client device 310 may include different or additional components, such as additional sensors, display, and software modules, etc.

The camera assembly 312 includes one or more cameras which can capture image data. The cameras capture image data describing a scene of the environment surrounding the client device 310 with a particular pose (the location and orientation of the camera within the environment). The camera assembly 312 may use a variety of photo sensors with varying color capture ranges and varying capture rates. Similarly, the camera assembly 312 may include cameras with a range of different lenses, such as a wide-angle lens or a telephoto lens. The camera assembly 312 may be configured to capture single images or multiple images as frames of a video.

The client device 310 may also include additional sensors for collecting data regarding the environment surrounding the client device, such as movement sensors, accelerometers, gyroscopes, barometers, thermometers, light sensors, microphones, etc. The image data captured by the camera assembly 312 can be appended with metadata describing other information about the image data, such as additional sensory data (e.g., temperature, brightness of environment, air pressure, location, pose etc.) or capture data (e.g., exposure length, shutter speed, focal length, capture time, etc.).

The gaming module 314 provides a player with an interface to participate in the parallel reality game. The game server 320 transmits game data over the network 370 to the client device 310 for use by the gaming module 314 to provide a local version of the game to a player at locations remote from the game server. In one embodiment, the gaming module 314 presents a user interface on a display of the client device 310 that depicts a virtual world (e.g., renders imagery of the virtual world) and allows a user to interact with the virtual world to perform various game objectives. In some embodiments, the gaming module 314 presents images of the real world (e.g., captured by the camera assembly 312) augmented with virtual elements from the parallel reality game. In these embodiments, the gaming module 314 may generate or adjust virtual content according to other information received from other components of the client device 310. For example, the gaming module 314 may adjust a virtual object to be displayed on the user interface according to a depth map of the scene captured in the image data.

The gaming module 314 can also control various other outputs to allow a player to interact with the game without requiring the player to view a display screen. For instance, the gaming module 314 can control various audio, vibratory, or other notifications that allow the player to play the game without looking at the display screen.

The positioning module 316 can be any device or circuitry for determining the position of the client device 310. For example, the positioning module 316 can determine actual or relative position by using a satellite navigation positioning system (e.g., a GPS system, a Galileo positioning system, the Global Navigation satellite system (GLONASS), the BeiDou Satellite Navigation and Positioning system), an inertial navigation system, a dead reckoning system, IP address analysis, triangulation and/or proximity to cellular towers or Wi-Fi hotspots, or other suitable techniques.

As the player moves around with the client device 310 in the real world, the positioning module 316 tracks the position of the player and provides the player position information to the gaming module 314. The gaming module 314 updates the player position in the virtual world associated with the game based on the actual position of the player in the real world. Thus, a player can interact with the virtual world simply by carrying or transporting the client device 310 in the real world. In particular, the location of the player in the virtual world can correspond to the location of the player in the real world. The gaming module 314 can provide player position information to the game server 320 over the network 370. In response, the game server 320 may enact various techniques to verify the location of the client device 310 to prevent cheaters from spoofing their locations. It should be understood that location information associated with a player is utilized only if permission is granted after the player has been notified that location information of the player is to be accessed and how the location information is to be utilized in the context of the game (e.g., to update player position in the virtual world). In addition, any location information associated with players is stored and maintained in a manner to protect player privacy.

The localization module 318 provides an additional or alternative way to determine the location of the client device 310. In one embodiment, the localization module 318 receives the location determined for the client device 310 by the positioning module 316 and refines it by determining a pose of one or more cameras of the camera assembly 312. The localization module 318 may use the location generated by the positioning module 316 to select a 3D map of the environment surrounding the client device 310 and localize against the 3D map. The localization module 318 may obtain the 3D map from local storage or from the game server 320. The 3D map may be a point cloud, mesh, or any other suitable 3D representation of the environment surrounding the client device 310. Alternatively, the localization module 318 may determine a location or pose of the client device 310 without reference to a coarse location (such as one provided by a GPS system), such as by determining the relative location of the client device 310 to another device.

In one embodiment, the localization module 318 applies a trained model to determine the pose of images captured by the camera assembly 312 relative to the 3D map. Thus, the localization model can determine an accurate (e.g., to within a few centimeters and degrees) determination of the position and orientation of the client device 310. The position of the client device 310 can then be tracked over time using dead reckoning based on sensor readings, periodic re-localization, or a combination of both. Having an accurate pose for the client device 310 may enable the gaming module 314 to present virtual content overlaid on images of the real world (e.g., by displaying virtual elements in conjunction with a real-time feed from the camera assembly 312 on a display) or the real world itself (e.g., by displaying virtual elements on a transparent display of an AR headset) in a manner that gives the impression that the virtual objects are interacting with the real world. For example, a virtual character may hide behind a real tree, a virtual hat may be placed on a real statue, or a virtual creature may run and hide if a real person approaches it too quickly.

The game server 320 includes one or more computing devices that provide game functionality to the client device 310. The game server 320 can include or be in communication with a game database 330. The game database 330 stores game data used in the parallel reality game to be served or provided to the client device 310 over the network 370.

The game data stored in the game database 330 can include: (1) data associated with the virtual world in the parallel reality game (e.g., image data used to render the virtual world on a display device, geographic coordinates of locations in the virtual world, etc.); (2) data associated with players of the parallel reality game (e.g., player profiles including but not limited to player information, player experience level, player currency, current player positions in the virtual world/real world, player energy level, player preferences, team information, faction information, etc.); (3) data associated with game objectives (e.g., data associated with current game objectives, status of game objectives, past game objectives, future game objectives, desired game objectives, etc.); (4) data associated with virtual elements in the virtual world (e.g., positions of virtual elements, types of virtual elements, game objectives associated with virtual elements; corresponding actual world position information for virtual elements; behavior of virtual elements, relevance of virtual elements etc.); (5) data associated with real-world objects, landmarks, positions linked to virtual-world elements (e.g., location of real-world objects/landmarks, description of real-world objects/landmarks, relevance of virtual elements linked to real-world objects, etc.); (6) game status (e.g., current number of players, current status of game objectives, player leaderboard, etc.); (7) data associated with player actions/input (e.g., current player positions, past player positions, player moves, player input, player queries, player communications, etc.); or (8) any other data used, related to, or obtained during implementation of the parallel reality game. The game data stored in the game database 330 can be populated either offline or in real time by system administrators or by data received from users (e.g., players), such as from a client device 310 over the network 370.

In one embodiment, the game server 320 is configured to receive requests for game data from a client device 310 (for instance via remote procedure calls (RPCs)) and to respond to those requests via the network 370. The game server 320 can encode game data in one or more data files and provide the data files to the client device 310. In addition, the game server 320 can be configured to receive game data (e.g., player positions, player actions, player input, etc.) from a client device 310 via the network 370. The client device 310 can be configured to periodically send player input and other updates to the game server 320, which the game server uses to update game data in the game database 330 to reflect any and all changed conditions for the game.

In the embodiment shown in FIG. 3, the game server 320 includes a universal game module 321, a commercial game module 323, a data collection module 324, an event module 326, a mapping system 327, an image localization module 328, and a 3D map store 329. As mentioned above, the game server 320 interacts with a game database 330 that may be part of the game server or accessed remotely (e.g., the game database 330 may be a distributed database accessed via the network 370). In other embodiments, the game server 320 contains different or additional elements. In addition, the functions may be distributed among the elements in a different manner than described.

The universal game module 321 hosts an instance of the parallel reality game for a set of players (e.g., all players of the parallel reality game) and acts as the authoritative source for the current status of the parallel reality game for the set of players. As the host, the universal game module 321 generates game content for presentation to players (e.g., via their respective client devices 310). The universal game module 321 may access the game database 330 to retrieve or store game data when hosting the parallel reality game. The universal game module 321 may also receive game data from client devices 310 (e.g., depth information, player input, player position, player actions, landmark information, etc.) and incorporates the game data received into the overall parallel reality game for the entire set of players of the parallel reality game. The universal game module 321 can also manage the delivery of game data to the client device 310 over the network 370. In some embodiments, the universal game module 321 also governs security aspects of the interaction of the client device 310 with the parallel reality game, such as securing connections between the client device and the game server 320, establishing connections between various client devices, or verifying the location of the various client devices 310 to prevent players cheating by spoofing their location.

The commercial game module 323 can be separate from or a part of the universal game module 321. The commercial game module 323 can manage the inclusion of various game features within the parallel reality game that are linked with a commercial activity in the real world. For instance, the commercial game module 323 can receive requests from external systems such as sponsors/advertisers, businesses, or other entities over the network 370 to include game features linked with commercial activity in the real world. The commercial game module 323 can then arrange for the inclusion of these game features in the parallel reality game on confirming the linked commercial activity has occurred. For example, if a business pays the provider of the parallel reality game an agreed upon amount, a virtual object identifying the business may appear in the parallel reality game at a virtual location corresponding to a real-world location of the business (e.g., a store or restaurant).

The data collection module 324 can be separate from or a part of the universal game module 321. The data collection module 324 can manage the inclusion of various game features within the parallel reality game that are linked with a data collection activity in the real world. For instance, the data collection module 324 can modify game data stored in the game database 330 to include game features linked with data collection activity in the parallel reality game. The data collection module 324 can also analyze data collected by players pursuant to the data collection activity and provide the data for access by various platforms.

The event module 326 manages player access to events in the parallel reality game. Although the term “event” is used for convenience, it should be appreciated that this term need not refer to a specific event at a specific location or time. Rather, it may refer to any provision of access-controlled game content where one or more access criteria are used to determine whether players may access that content. Such content may be part of a larger parallel reality game that includes game content with less or no access control or may be a stand-alone, access controlled parallel reality game.

The mapping system 327 generates a 3D map of a geographical region based on a set of images. The 3D map may be a point cloud, polygon mesh, or any other suitable representation of the 3D geometry of the geographical region. The 3D map may include semantic labels providing additional contextual information, such as identifying objects tables, chairs, clocks, lampposts, trees, etc.), materials (concrete, water, brick, grass, etc.), or game properties (e.g., traversable by characters, suitable for certain in-game actions, etc.). In one embodiment, the mapping system 327 stores the 3D map along with any semantic/contextual information in the 3D map store 329. The 3D map may be stored in the 3D map store 329 in conjunction with location information (e.g., GPS coordinates of the center of the 3D map, a ringfence defining the extent of the 3D map, or the like). Thus, the game server 320 can provide the 3D map to client devices 310 that provide location data indicating they are within or near the geographic area covered by the 3D map.

The network 370 can be any type of communications network, such as a local area network (e.g., an intranet), wide area network (e.g., the internet), or some combination thereof. The network can also include a direct connection between a client device 310 and the game server 320. In general, communication between the game server 320 and a client device 310 can be carried via a network interface using any type of wired or wireless connection, using a variety of communication protocols (e.g., TCP/IP, HTTP, SMTP, FTP), encodings or formats (e.g., HTML, XML, JSON), or protection schemes (e.g., VPN, secure HTTP, SSL).

This disclosure makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, processes disclosed as being implemented by a server may be implemented using a single server or multiple servers working in combination. Databases and applications may be implemented on a single system or distributed across multiple systems. Distributed components may operate sequentially or in parallel.

In situations in which the systems and methods disclosed access and analyze personal information about users, or make use of personal information, such as location information, the users may be provided with an opportunity to control whether programs or features collect the information and control whether or how to receive content from the system or other application. No such information or data is collected or used until the user has been provided meaningful notice of what information is to be collected and how the information is used. The information is not collected or used unless the user provides consent, which can be revoked or modified by the user at any time. Thus, the user can have control over how information is collected about the user and used by the application or system. In addition, certain information or data can be treated in one or more ways before it is stored or used, so that personally identifiable information is removed. For example, a user's identity may be treated so that no personally identifiable information can be determined for the user.

The image localization module 328 generates feature tokens for images and uses image similarity to identify reference images for camera localization. The image localization module 328 receives initial location data for a query image, which represents an approximate location of where the query image was captured. The image localization module 328 generates feature tokens for the query image and accesses a set of images with known poses near the approximate location. The image localization module 328 uses image similarity of features to identify reference images that are most relevant to the query image. After generating feature tokens for the selected reference images, the image localization module 328 randomly samples those feature tokens. The image localization module 328 may randomly sample a set number of feature tokens, no matter how many reference images are used. The image localization module 328 uses a transformer to localize the query image based on the random sample of feature tokens. The image localization module 328 may output a global pose or a pose within a scene.

The game server receives 400 an image from a client device. The image may be captured by a camera of the client device and may depict an environment around the client device. The image may be a singular still image captured at a specific moment in time or a frame extracted from a video sequence captured by the client device. The game server may process individual frames from a video stream as separate images for localization purposes. The game server may receive multiple images from the client device over time as the client device moves through different locations.

The image may be associated with an estimated pose. The estimated pose is a pose describing the position or orientation of the client device when the image was captured. For example, the estimated pose may be three-dimensional coordinates describing a location in which the image was captured or may be six-dimensional coordinates describing a location and an orientation for the image. The estimated pose may be an initial estimate of the pose where the image was captured and may include uncertainty information indicating the confidence level or accuracy range of the pose estimate. In some embodiments, the estimated pose may be an area in which the image was captured rather than a specific coordinate location. The game server may receive this estimated pose along with the image data from the client device. Alternatively, the game sensor may receive sensor data captured by a sensor of the client device and may calculate the estimated pose based on the sensor data.

The game server generates 410 a set of feature tokens for the image. A feature token describes a set of features that describe a portion of the image. For example, the feature token may include a feature vector or embedding that represents visual characteristics of the image portion. The feature token may describe visual elements such as edges, textures, colors, shapes, or spatial relationships within the image portion. Similarly, the feature token may encode information about object boundaries, surface patterns, lighting conditions, or geometric structures present in the image.

The game server may generate the feature tokens using a feature encoder. A feature encoder is a machine-learning model trained to generate feature tokens based on input images. For example, the feature encoder may be an encoder of a foundation model that has been trained on large datasets of images to learn general visual representations. In some embodiments, the feature encoder may be a Vision Transformer (ViT) encoder that tokenizes the images and extracts features from the images.

The game server selects 420 a set of reference images to use in localizing the received image. Reference images are images with associated poses that can serve as references for predicting pose of an image. For example, a reference image may be an image of a building captured from a specific location with known GPS coordinates and camera orientation data. The game server may access a database or storage system that contains the reference images along with their corresponding pose data. Reference images may be further associated with geographic areas or points of interest within the virtual world or real-world environment.

The game server may select the set of reference images based on the estimated pose of the image. For example, the game server may compare the estimated pose of the received image with the poses of the reference images to identify reference images to use. The game server may select reference images with poses within a threshold distance of the estimated pose of the image or may select N closest reference images based on the estimated pose of the image and the poses associated with the reference images. The game server may also select reference images based on angular similarity between viewing directions or orientations. For example, the game server may select reference images that were captured with camera orientations within a threshold angle of the estimated orientation of the received image. The game server may apply filtering criteria that consider both positional proximity and directional alignment when selecting the reference images.

The game server accesses 430 feature tokens for the selected reference images. These feature tokens may be generated by the feature encoder using the same process applied to the received image. The game server may dynamically generate the feature tokens when the image is received. Alternatively, the game server may retrieve pre-generated feature tokens from a storage system or database that contains the feature tokens corresponding to each reference image.

The feature tokens for the reference images may include information about poses of the corresponding reference image. For example, the feature tokens may include features that encode pose information directly within a feature vector of the feature token. Similarly, a feature token with an embedding may encode pose information within the embedding.

In some embodiments, the game server may compute ray vectors for feature tokens of the reference images and encode that information into those feature tokens. Each token may correspond to a portion of the reference image. The game server may compute a viewing direction vector representing a direction of view of the portion of the reference image for the feature token from the pose of the corresponding reference image. The game server may calculate the viewing direction by projecting from the estimated pose of the image through the image portion into three-dimensional space. Thus, a ray may be the combination of the viewing direction vector and the camera position. The game server may generate an encoding of the vector and camera position and incorporate that encoding into the feature token. For example, the game server may add the ray encoding as part of a feature vector of the token or by add or concatenating the ray encoding with an embedding of the feature token.

The game server selects 440 a subset of the feature tokens for the reference images. The game server may select a sparse set of feature tokens, such as fewer than 5,000 feature tokens, fewer than 1,000 feature tokens, or fewer than 300 feature tokens from the complete set of feature tokens available for the reference images. For example, the game server may select a predetermined number of feature tokens from the complete set of feature tokens available for the reference images. The feature tokens may be evenly selected from the set of reference images such that a feature token is selected for each reference image. For example, the game server may select an equal number of feature tokens from each reference image. Alternatively, the game server may randomly select the subset of feature tokens from the set of feature tokens for the reference images. For example, the game server may apply a random sampling process to choose feature tokens e.g., without regard to their source reference image or spatial location within the images.

The game server applies 450 a foundation model to the set of feature tokens for the received image and the selected subset of the set of feature tokens to predict a final pose for the image. The foundation model predicts the final pose for the image in a single feed-forward pass. The foundation model is a machine-learning model that is trained to predict poses for images. For example, the foundation model may be a transformer model that is trained to predict poses based on input feature tokens. In some embodiments, the transformer may include the feature encoder that was used to generate the initial feature tokens. In these embodiments, the game server may apply the foundation model by applying a decoder of the transformer model to the input feature tokens.

The game server may apply scene and scale normalization to the feature tokens and pose data before processing by the foundation model. The game server may normalize the scene by defining one of the reference images as a reference point and mapping all other reference images such that their poses are relative to this reference point. The game server may place the scene at the origin of a coordinate system by applying this normalization. The game server may also normalize the scale of the reference image poses by computing a scene scale as the largest camera translation in any spatial coordinate after scene normalization. The game server may normalize all camera translations by dividing each translation component by the computed scene scale. The game server may multiply the predicted coordinates output by the foundation model by the scene scale to recover the true scale of the scene. This scene and scale normalization may enable the foundation model to generalize to new domains with different scale ranges and may abstract the task of learning metric coordinates from the poses and images.

In some embodiments, the foundation model may predict 3D points, such as scene coordinates, rather than directly outputting the final pose. The game server may use these predicted 3D points along with image pixel information to generate 2D-3D correspondences between the received image and the three-dimensional scene. The game server may input these 2D-3D correspondences into a Perspective-n-Point (PnP) algorithm, which computes and returns the pose of the received image. While the system output is the pose, the pose is not directly the output of the foundation model but rather the output of a geometric algorithm that processes the foundation model's predictions as input.

The game server generates 460 AR content based on the image and the final pose. For example, the game server may use the final pose to position virtual objects within a three-dimensional coordinate system of the environment captured by the image. The game server may overlay virtual elements onto the image by calculating their projected positions based on the final pose and camera parameters. The game server may generate virtual characters, items, or interactive elements that appear to exist within the real-world environment depicted in the image. The game server may apply occlusion calculations to ensure virtual objects appear behind or in front of real-world objects based on their relative positions. The game server may adjust lighting and shading of virtual content to match the environmental conditions captured in the image. The game server may generate depth information for virtual objects to create interactions with the physical environment.

The game server transmits 470 the AR content to the client device for presentation to a user on a display on the client device. The game server may encode the AR content as digital data that includes position coordinates, visual assets, and rendering instructions. The game server may send the AR content through the network connection between the game server and the client device. The game server may transmit the AR content as a data stream that the client device can process for display purposes with specified latency bounds. The client device may receive the AR content and render it on a screen or display interface for viewing by the user. The game server may include metadata with the AR content that specifies how the virtual elements should be positioned relative to the camera view of the client device.

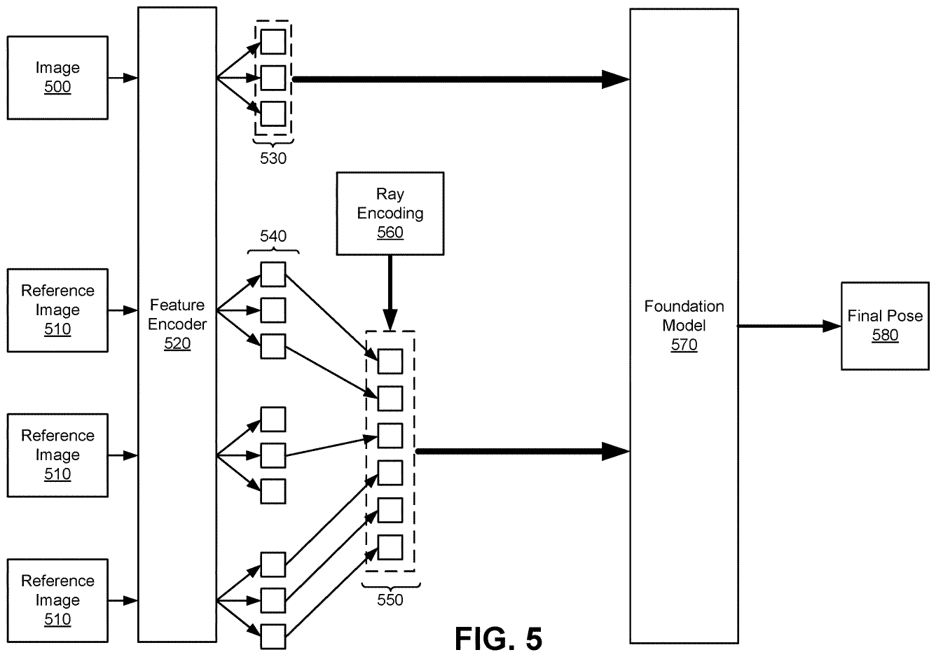

FIG. 5 illustrates an example data flow for generating a final pose for an image using reference images and a foundation model, in accordance with some embodiments. A game server receives an image 500 from a client device. The game server uses an estimated pose for the image to select a set of reference images 510 for the image. The game server applies a feature encoder 520 to the image 500 to generate a set of feature tokens 530 for the image. The game server also may apply the feature encoder to each of the reference images to generate sets of feature tokens 540 for the reference images. The game server selects a subset 550 of the feature tokens from the sets of feature tokens generated for the reference images. The game server may incorporate ray encoding information 560 into the subset of feature tokens. The game server inputs the feature tokens 530 from the image and the subset of feature tokens 560 to a foundation model 570 to generate a prediction of a final pose 580 at which the image was captured.

### Additional Considerations

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. For example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a system and a process for providing the described functionality. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving an image from a client device, wherein image is associated with an estimated pose;
generating a set of feature tokens for the image by applying a feature encoder to the received image, wherein the feature encoder is a machine-learning model that is trained to generate feature tokens describing portions of images input to the feature encoder, wherein each feature token of the set of feature tokens comprises a set of features describing a portion of the image;
selecting a set of reference images from a plurality of reference images based on the estimated pose of the image, wherein each reference image of the plurality of reference images is associated with a pose at which the reference image was captured;
accessing a set of feature tokens for each of the set of reference images, wherein the set of feature tokens for each of the set of reference images comprises feature tokens generated by the feature encoder based on the corresponding reference image and the pose of the corresponding reference image;
selecting a subset of the set of feature tokens for input to a foundation model;
applying the foundation model to the set of feature tokens for the received image and the selected subset of the set of feature tokens to generate a final pose for the image, wherein the foundation model is a machine-learning model that is trained to predict poses for images based on input feature tokens for images;
generating AR content based on the image and the final pose; and
transmitting the AR content to the client device for presentation to a user on a display on the client device.

2. The computer-implemented method of claim 1, further comprising:
estimating the pose for the received image based on sensor data captured by the client device.

3. The computer-implemented method of claim 1, wherein selecting the subset of the set of feature tokens comprises:
selecting the subset of feature tokens such that the subset of feature tokens are evenly distributed among the set of reference images.

4. The computer-implemented method of claim 1, wherein selecting the subset of the set of feature tokens comprises:
selecting the subset of feature tokens such that the subset of feature tokens are randomly distributed among the set of reference images.

5. The computer-implemented method of claim 1, further comprising:
generating the feature tokens for each of the set of reference images based on the feature encoder.

6. The computer-implemented method of claim 5, wherein generating the feature tokens for each of the set of reference image comprises:
computing a ray from the pose of the corresponding reference image in a direction of a portion of the reference image corresponding to the feature token.

7. The computer-implemented method of claim 1, wherein generating the feature tokens is responsive to selecting the set of reference images.

8. The computer-implemented method of claim 1, wherein the foundation model comprises a transformer model, the transformer model including the feature encoder.

9. The computer-implemented method of claim 1, wherein selecting the set of reference images comprises:
selecting reference images with poses within a threshold distance of the estimated pose of the image.

10. The computer-implemented method of claim 1, wherein selecting the set of reference images comprises:
selecting N closest reference images based on the estimated pose of the image.

11. A non-transitory computer-readable medium storing computer-executable instructions that, when executed, cause a computing system to perform operations comprising:
receiving an image from a client device, wherein image is associated with an estimated pose;
generating a set of feature tokens for the image by applying a feature encoder to the received image, wherein the feature encoder is a machine-learning model that is trained to generate feature tokens describing portions of images input to the feature encoder, wherein each feature token of the set of feature tokens comprises a set of features describing a portion of the image;
selecting a set of reference images from a plurality of reference images based on the estimated pose of the image, wherein each reference image of the plurality of reference images is associated with a pose at which the reference image was captured;
accessing a set of feature tokens for each of the set of reference images, wherein the set of feature tokens for each of the set of reference images comprises feature tokens generated by the feature encoder based on the corresponding reference image and the pose of the corresponding reference image;
selecting a subset of the set of feature tokens for input to a foundation model;
applying the foundation model to the set of feature tokens for the received image and the selected subset of the set of feature tokens to generate a final pose for the image, wherein the foundation model is a machine-learning model that is trained to predict poses for images based on input feature tokens for images;
generating AR content based on the image and the final pose; and
transmitting the AR content to the client device for presentation to a user on a display on the client device.

12. The computer-readable medium of claim 11, the operations further comprising:
estimating the pose for the received image based on sensor data captured by the client device.

13. The computer-readable medium of claim 11, wherein selecting the subset of the set of feature tokens comprises:
selecting the subset of feature tokens such that the subset of feature tokens are evenly distributed among the set of reference images.

14. The computer-readable medium of claim 11, wherein selecting the subset of the set of feature tokens comprises:
selecting the subset of feature tokens such that the subset of feature tokens are randomly distributed among the set of reference images.

15. The computer-readable medium of claim 11, the operations further comprising:
generating the feature tokens for each of the set of reference images based on the feature encoder.

16. The computer-readable medium of claim 15, wherein generating the feature tokens for each of the set of reference image comprises:
computing a ray from the pose of the corresponding reference image in a direction of a portion of the reference image corresponding to the feature token.

17. The computer-readable medium of claim 11, wherein generating the feature tokens is responsive to selecting the set of reference images.

18. The computer-readable medium of claim 11, wherein the foundation model comprises a transformer model, the transformer model including the feature encoder.

19. The computer-readable medium of claim 11, wherein selecting the set of reference images comprises:
selecting reference images with poses within a threshold distance of the estimated pose of the image.

20. The computer-readable medium of claim 11, wherein selecting the set of reference images comprises:
selecting N closest reference images based on the estimated pose of the image.
